(19) United States
(12) Patent Application Publication
(10) Pub. No.: US 2026/0217041 A1
(43) Pub. Date: Jul. 30, 2026

(54) PRINTER PROTECTION DEVICE FOR A PRINTER MODULE USED AT A PACKAGING MACHINE AND METHOD

(71) Applicant: MULTIVAC MARKING & INSPECTION GMBH & CO. KG, Enger (DE)

(72) Inventors: Markus DAUWE, Hilter (DE); Malte SIEKMANN, Bielefeld (DE); Sven KÜWERT, Leopoldshöhe (DE); Udo HENRICHS, Bielefeld (DE)

(73) Assignee: MULTIVAC MARKING & INSPECTION GMBH & CO. KG, Enger (DE)

(21) Appl. No.: 19/459,912

(22) Filed: Jan. 26, 2026

(30) Foreign Application Priority Data
Jan. 28, 2025 (DE) 102025102890.7

(51) Int. Cl. B41J 29/13; B41J 29/02; B65B 61/02

(52) U.S. Cl. CPC B41J 29/13; B41J 29/02; B65B 61/025

(57) ABSTRACT

A printer protection device for a printer module used at a packaging machine, in particular for a thermal transfer printer, which can be controlled to produce a print image on labels or to produce a print image on a packaging film, wherein the printer protection device has a waterproof foldable protective hood with a hood opening that is configured to receive, in a sealing manner, an attachment plate that supports the printer module.

### CROSS-REFERENCE TO RELATED APPLICATIONS

This application claims foreign priority benefits under 35 U.S.C. § 119(a)-(d) to German patent application number DE 102025102890.7, filed January 28, 2025, which is incorporated by reference in its entirety.

### TECHNICAL FIELD

The present disclosure relates to a printer protection device for a printer module used at a packaging machine. Furthermore, the disclosure relates to a method for configuring a packaging machine for a cleaning process and to the use of a protective hood.

### BACKGROUND

Printer modules used at packaging machines, for example, at deep-drawing packaging machines, tray sealing machines, or at flow-packing machines, which are used to print labels or directly print onto packaging materials, such as a top film, can be isolated from the cleaning fluids used during a cleaning process of the packaging machine only with difficulty or with great effort without being dismantled for this purpose.

DE 102022111562 A1 discloses a printer device with a sealing unit that can be adjusted by way of a lifting mechanism between a first position, in which the sealing unit exposes a print head, and a second position, in which the sealing unit closes the print head for a cleaning process. This allows a nozzle provided at the print head to be reliably sealed during a cleaning process in order to prevent cleaning fluid from reaching it. However, the adjustably mounted sealing unit takes up space at the printer device and increases manufacturing costs and cleaning efforts.

### SUMMARY

The object of the disclosure is to provide an inexpensive and practically applicable printer protection device for a printer module used at a packaging machine by way of which the printer module can be reliably protected during a cleaning process. Furthermore, the object of the disclosure is to provide a method for configuring a packaging machine for a cleaning process which can be inexpensive and practical to implement in order to reliably protect the printer module from cleaning fluids during the cleaning process.

This object is satisfied by a printer protection device according to the disclosure and by way of a method according to the disclosure. The object of the disclosure can also be satisfied by way of the inventive use according to the disclosure.

The disclosure relates to a printer protection device for a printer module used at a packaging machine, in particular for a thermal transfer printer, which can be controlled to produce a print image on labels or to produce a print image on a packaging film.

The disclosure provides that the printer protection device has a waterproof, foldable protective hood with a hood opening that is configured to receive an attachment plate in a sealing manner that supports the printer module. Basically, the hood opening of the protective hood forms a positive-fitted receptacle for the attachment plate in order to be able to form a waterproof receiving chamber for the printer module together with the attachment plate.

The hood opening is therefore configured as a sealing receptacle for the attachment plate on which the printer module is positioned. The protective hood according to the disclosure can therefore be attached to the attachment plate for a cleaning process in such a way that, together with the attachment plate, it forms a waterproof all-round protection for the printer module that is placed on the attachment plate. By receiving the attachment plate within the hood opening of the protective hood in a sealing manner, a waterproof receiving chamber for the printer module can be formed therebetween in which the printer module can be received in a completely isolated manner so that it remains reliably shielded from cleaning fluids during a cleaning process.

The disclosure is therefore based on the idea of forming a waterproof enclosure or a waterproof receiving chamber for the printer module for a cleaning process by assembling the protective hood according to the disclosure with an attachment plate supporting the printer module in order to be able to receive the printer module in a completely isolated manner so that no cleaning fluids can reach the printer module. Due to the fact that the protective hood according to the disclosure interacts with an attachment plate already existing at the packaging machine and supporting the printer module to form the receiving chamber, an overall compact and inexpensive protection for the printer module can be produced without great effort.

Due to the fact that the protective hood is configured to be foldable, it can be collapsed to form one or more folds, such that it is present with reduced volume and can thereby be stowed or stored in a space-saving manner. The foldable design also allows for the protective hood to be in particular also gently attached over or slipped over the printer module, even when the space is confined.

Preferably, the protective hood has a frame that is configured to be reinforced as a skirting to form the hood opening for enclosing the attachment plate. The attachment plate can be received therein in a positive-fit manner and, in particular, in a force-fit manner, to form the waterproof receiving chamber therebetween. The shape of the frame can be configured to correspond to the shape of the attachment plate, in particular be round or square.

A preferred variant provides for the frame thickness of the frame to be sized to correspond in size to at least the thickness of the attachment plate. This creates a stable receptacle for the attachment plate. As a result, the protective hood can be attached particularly securely to the attachment plate using the frame which ensures that the protective hood remains reliably mounted along the circumference of the attachment plate during the cleaning process.

In particular, the frame is made from PVC, in particular from rigid PVC. This creates a robust receptacle for the attachment plate into which the attachment plate can be inserted with a perfect seal during a cleaning process. This also results in the sealing interface between the protective hood and the attachment plate being created between solid materials which results in a reliable seal.

An advantageous embodiment provides for the frame to have at least one sealing element that can be attached in a sealing manner to a circumference of the attachment plate. In a state in which the protective hood is attached to the attachment plate, the sealing element preferably seals along the entire circumference of the attachment plate. A sealing cord running all the way around the inner circumference of the frame is used as the sealing element on the frame. The former can be fastened within a groove formed along the inner circumference of the frame.

It would be conceivable for the frame and the sealing element to be manufactured as a composite injection-molded component. Alternatively, the sealing element can be glued or welded to the frame. One variant provides for the frame itself to be made of a material that seals against the attachment plate, i.e., without a separate sealing element.

According to one embodiment, the printer protection device comprises an attachment plate supporting the printer module for detachably attaching the protective hood. The attachment plate can be received as a closure within the hood opening of the protective hood in a positive-fit manner and, in particular, in a force-fit manner. The printer protection device thus combines the technical advantages of the protective hood with the technical advantages of the attachment plate. The attachment plate supporting the printer module is already present as a stable support plate, in particular as an adjustably mounted support plate, for the printer module at the packaging machine and can additionally be used as a sealing closure at the hood opening of the protective hood. The attachment plate forms a stable base for attaching the protective hood to form a waterproof receiving chamber for the printer module. Due to the foldable design of the protective hood, it can be attached to the attachment plate even in confined spaces.

Preferably, the protective hood can be locked to the attachment plate. In particular, the protective hood is configured to be lockable to the attachment plate without the need for tools. One variant provides for several locking elements to be provided on the frame of the protective hood, in particular at the corner regions formed thereon, by way of which the protective hood can be locked to the attachment plate. For this purpose, for example, rear-engagement elements that are attached to be rotatable to the frame of the protective hood are used. When the protective hood is in a state of being attached to the attachment plate, they can be pivoted such that they rest against a side of the attachment plate facing away from the printer module.

According to one embodiment of the disclosure, the hood opening, in particular the frame forming the hood opening, comprises at least one stop for the attachment plate. It can be configured, for example, in the form of a projection running along the inner circumference of the frame. This allows the protective hood to assume a predetermined position on the attachment plate. In other words, the attachment plate can be inserted into the hood opening to a predetermined depth, namely until it abuts against the stop.

It would be conceivable for the sealing element to be provided at the stop, in particular at the base of the stop. It can be reliably affixed, in particular at the latter location. Furthermore, it would be possible to lock the protective hood to the attachment plate with a predetermined clamping force, by way of which the sealing element is clamped for achieving a desired sealing effect. The rear-engagement elements could, for example, exert a desired clamping force upon the sealing element in the locked state.

The protective hood preferably has welded seams. In particular, all seams formed on the protective hood are welded to be waterproof.

It would be expedient for the protective hood to be formed as a cuboid-shaped hood. This would allow the printer module to be well covered. In particular, the hood could be configured to be formed to correspond to the shape of the printer module, only slightly larger than the latter, i.e., the shape of the hood is substantially congruent with the shape of a printer module housing so that the hood can be attached precisely as a cover over the printer module. This allows cleaning agents to flow more easily off of the protective hood during the cleaning process.

When in the state attached to the attachment plate, it would be conceivable for the hood to abut against the printer module like a second skin. For this purpose, the hood can be configured, in particular, as a stretchable cover. This allows cleaning agents to flow off of the protective hood even better during the cleaning process.

According to a preferred variant of the disclosure, the protective hood is made from PVC canvas, in particular from PVC-coated polyester fabric, or of polyester fabric. In particular, it is possible for the frame and the hood to be integrally connected to one another at the protective hood, in particular by being welded in a positive substance-fit manner, in order to form a waterproof enclosure. Alternatively, a connection in a positive substance-fit manner between the frame and the hood of the protective hood could also be created by way of adhesive bonding.

The disclosure further relates to a printer device comprising a printer rack and at least one printer module mounted thereon to be movable, wherein the printer module, in particular a thermal transfer printer, can be moved together with an attachment plate supporting the printer module from a region located inside the printer rack to a position outside the printer rack for attachment or to form a printer protection device according to the disclosure, respectively. The region located within the printer rack includes, in particular, the printing region of the printer module, wherein the printer module can be moved on the attachment plate from the printing region to the cleaning position disposed outside the printer rack, where the attachment plate is positioned for easy access for attaching the protective hood.

It would be conceivable for the attachment plate, including the printer module positioned thereon, to be moved manually and/or by servomotor from the printer rack to the position disposed outside for attaching the printer protection device according to the disclosure.

One variant provides for the printer device to have several printer modules movable along parallel travel tracks, each of which can be moved together with an attachment plate supporting the respective printer module from a region within the printer rack to a position disposed outside the printer rack for attachment or to form a respective printer protection device according to the disclosure.

The disclosure further relates to a packaging machine configured as a deep-drawing packaging machine, a tray sealing machine (also known in the art as a tray sealer), or a flow-packaging machine (also known in the art as a flow packer), at which at least one printing device is provided. The printing device, whose movable attachment plate, including the printer module positioned thereon, can be moved to a position disposed outside the printer rack for attaching a printer protection device according to the disclosure, can be used, for example, in the region of a top film transport device of the deep-drawing packaging machine or the tray sealer for printing onto the top film material. On a flow packer, the printing device could be positioned at the entrance to a tube forming station in order to print directly onto the film used to form the material tube or onto labels to be applied thereto.

The disclosure further relates to a method for configuring a packaging machine for a cleaning process. The method according to the disclosure provides that a waterproof, foldable protective hood is placed in a sealing manner by way of a hood opening formed thereon onto a plate edge of an attachment plate used to support a printer module, which edge is formed to correspond to the hood opening.

In the mounted, i.e., assembled state, the attachment plate is inserted as a closure or lid into the hood opening of the protective hood with a precise fit to form a waterproof receiving chamber for the printer module therebetween. In the disclosure, the hood opening of the protective hood is sized as a receptacle for the attachment plate into which the attachment plate can be inserted as a sealing closure or lid to form a waterproof receiving chamber for the printer module therebetween.

Due to the fact that the hood opening formed on the protective hood according to the disclosure can be placed in a sealing manner onto the plate edge of the attachment plate, since a positive-fit connection and, in particular, force-fit connection can be established between them, the printer module can be well protected and isolated during a cleaning process.

To place the protective hood on the attachment plate, the latter together with the printer module mounted thereon is preferably moved to a position outside of the printing region. This can be done manually or with motor support, e.g., a servo motor. In this exposed position, the protective hood can be easily attached to the plate edge of the attachment plate. In particular, the protective hood can be locked to the attachment plate in this position in a simple manner.

The disclosure further relates to the use of a hood opening of a waterproof foldable protective hood as a sealing receptacle for an attachment plate supporting a printer module to form a waterproof receiving chamber for the printer module. This allows for reliable protection for the printer module during a cleaning process to be produced inexpensively using fewer components. A protective hood used for this purpose can be easily placed upon the attachment plate even in confined spaces and is suitable for space-saving storage.

### BRIEF DESCRIPTION OF THE DRAWINGS

Embodiments according to the disclosure shall be explained in more detail with reference to the following figures, where:

FIG. 1 shows a printer protection device in the form of a protective hood,

FIG. 2 shows a perspective view of a printer device,

FIG. 3 shows a perspective rear view of the printer device from FIG. 2,

FIG. 4 shows an enlarged view of a printer module protected for a cleaning process,

FIG. 5 shows a packaging machine in the form of a flow-packing machine with a printer device according to FIG. 2,

FIG. 6 shows a packaging machine in the form of a deep-drawing packaging machine with a printer device according to FIG. 2, and

FIG. 7 shows a packaging machine in the form of a tray sealing machine with a printer device according to FIG. 2.

Identical technical features in the figures are provided throughout with the same reference signs.

### DETAILED DESCRIPTION

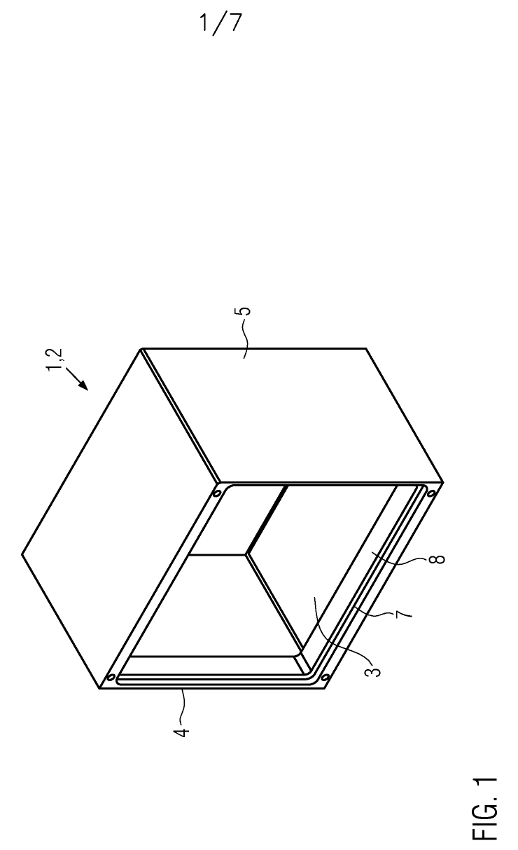

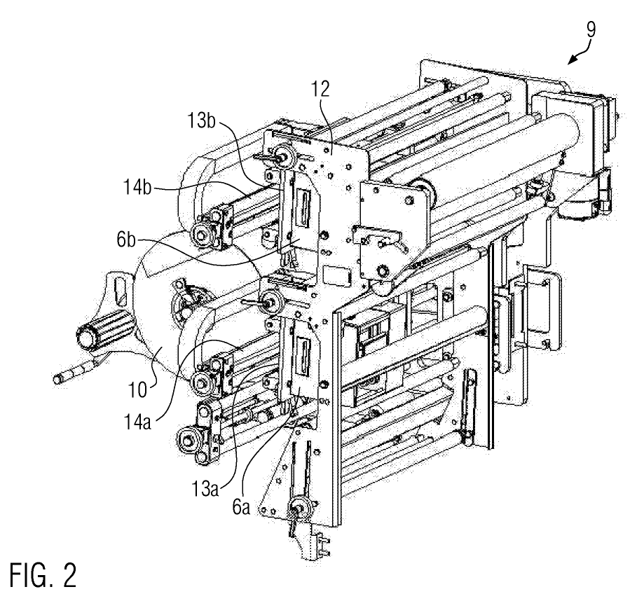

FIG. 1 shows a printer protection device 1 in the form of a foldable protective hood 2. Protective hood 2 forms a hood opening 3 which is defined by a reinforcing frame 4. Frame 4 is welded or glued to a hood 5. Hood 5 is made from waterproof foldable material, e.g., PVC-coated polyester fabric. Protective hood 2 shown in FIG. 1 can be used as a cleaning protection hood for a printer module 6a, 6b (see FIG. 2).

A groove 7, within which a sealing cord running all the way around the inner circumference of frame 4 can be received, is formed along an inner circumference of frame 4 shown in FIG. 1. Furthermore, FIG. 1 shows that frame 4 is formed with a circumferential rim 8 to which foldable hood 5 is attached. For example, hood 5 can be welded or glued to rim 8 in order to create a permanently fixed waterproof connection between frame 4 and hood 5.

Frame 4 on protective hood 2 shown in FIG. 1 forms a structurally rigid element to which hood 5, which is flexible and foldable unlike frame 4, is attached. By way of reinforcing frame 4, protective hood 2 shown in FIG. 1 can form a dimensionally stable hood opening 3.

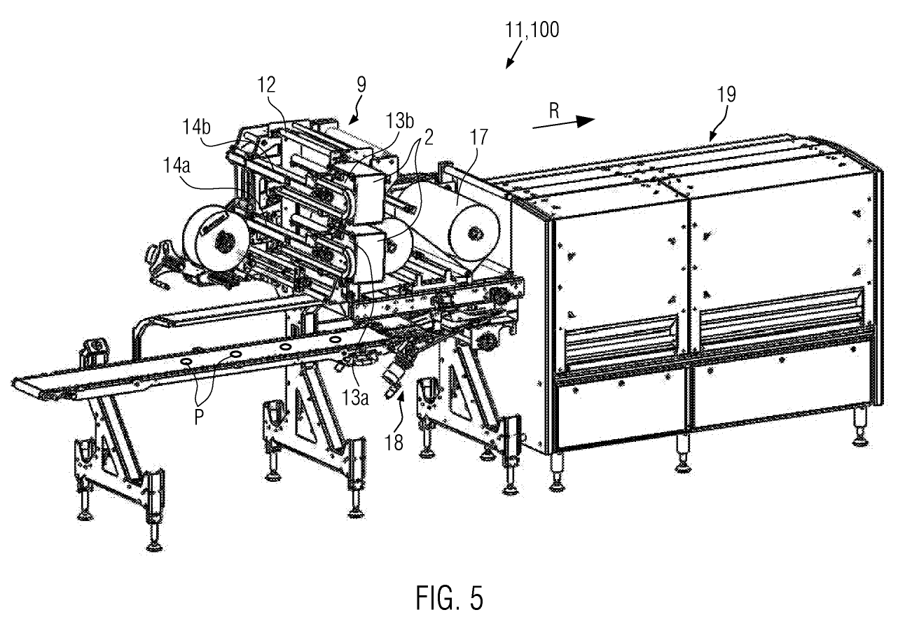

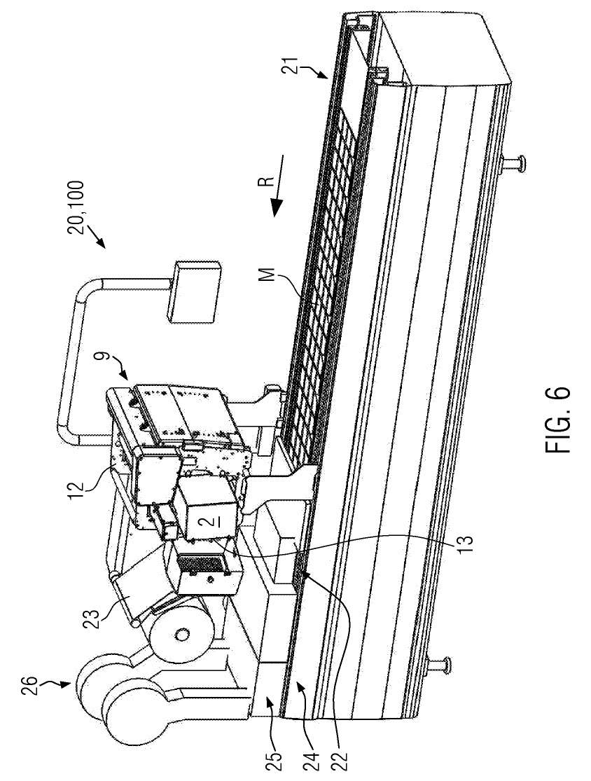

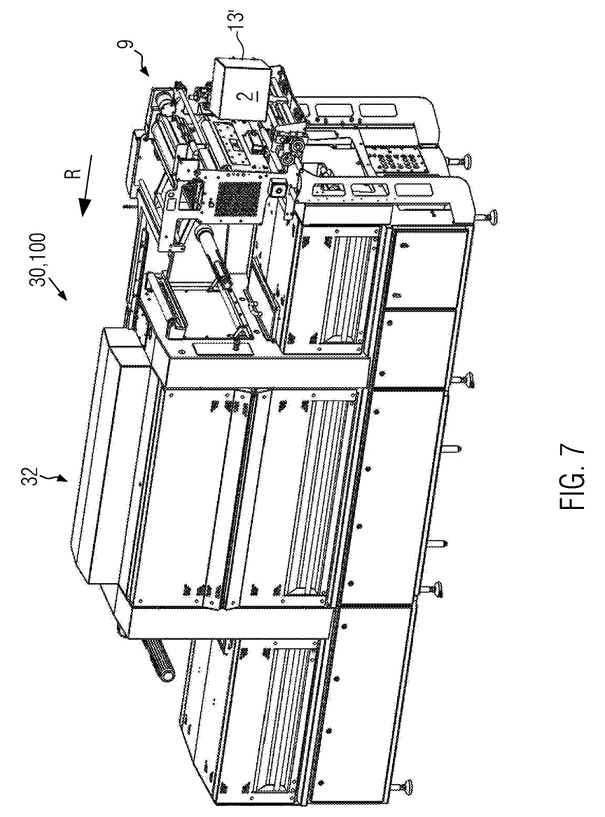

FIG. 2 shows a printer device 9. Printer device 9 comprises two printer modules 6a, 6b. These printer modules 6a, 6b can be used to print onto labels that are unwound from a label roll 10 or onto a packaging film, in particular top film material, that is fed to printer device 9. Printer device 9 can be used for various types of packaging machine, for example, for a packaging machine 100 in the form of a flow-packaging machine 11 (see FIG. 5), in the form of a deep-drawing packaging machine 20 (see FIG. 6), or in the form of a tray sealing machine 30 (see FIG. 7).

Printer device 12 shown in FIG. 2 could also be equipped with only one printer module 6a, 6b for printing onto labels or directly onto a packaging film on one of the aforementioned types of packaging machines.

In FIG. 2, both printer modules 6a, 6b are configured as thermal transfer printers. Printer device 9 comprises a printer rack 12 on which printer modules 6a, 6b are mounted in a movable manner. When in the state mounted at a packaging machine 100, printer modules 6a, 6b can be moved transversely to a production direction R of packaging machine 100.

Printer modules 6a, 6b positioned within printer rack 12 in FIG. 2 are each mounted on an attachment plate 13a, 13b. Guides 14a, 14b along which printer modules 6a, 6b can move are provided for respective printer modules 6a, 6b.

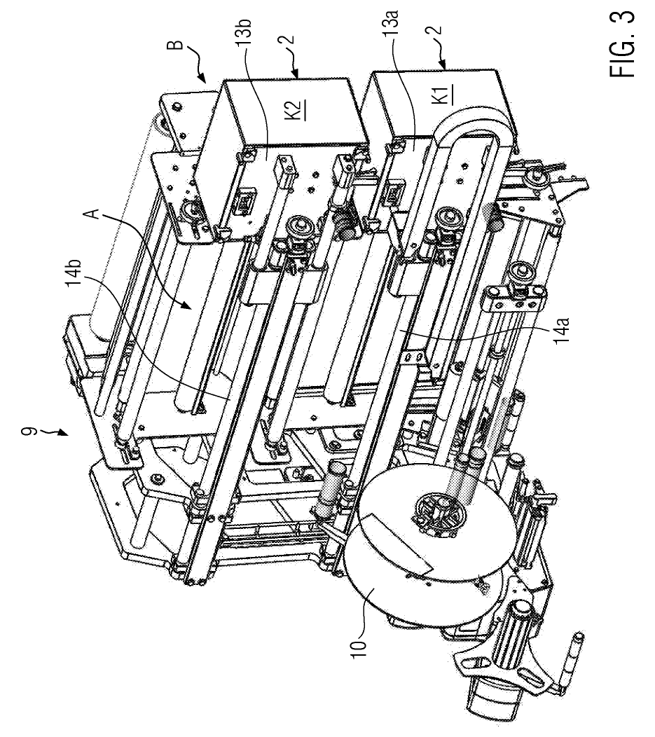

FIG. 3 shows printer device 9 from FIG. 2 in a perspective rear view. For a cleaning process, as shown in FIG. 3, two printer modules 6a, 6b, together with attachment plates 13a, 13b supporting them, can each be moved from a region A located within printer rack 12, in which the printing region is located, to a position B located outside printer rack 12, i.e., to a cleaning position. In this exposed position B, respective protective hoods 2 can be easily attached to attachment plates 13a, 13b, as shown in FIG. 3, such that waterproof receiving chambers K1, K2 for respective printer modules 6a, 6b are formed between them.

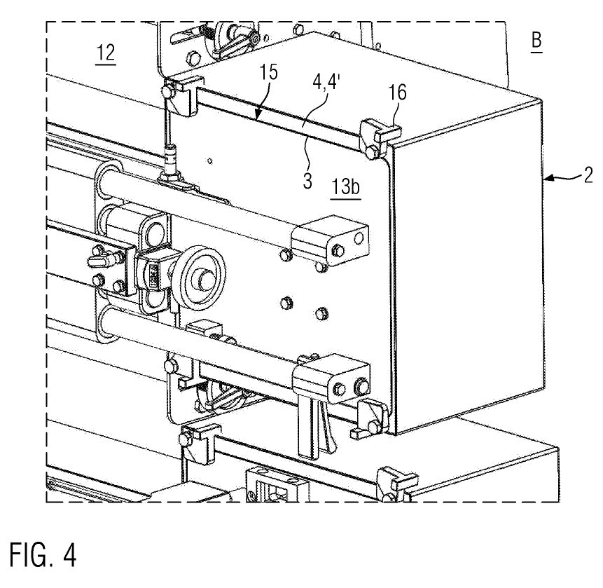

FIG. 4 shows, in an enlarged view, how protective hood 2 can be securely attached to attachment plate 13b. According to FIG. 4, attachment plate 13b, together with printer module 6b positioned thereon (not visible in FIG. 4), is moved to position B located outside printer rack 12. In this position B, attachment plate 13b is easily accessible for an operator to attach protective hood 2 thereonto. FIG. 4 shows that attachment plate 13b is received in a positive-fit manner in hood opening 3 formed by frame 4, i.e., it is inserted as a sealing closure into hood opening 3 of protective hood 2 in order to form a completely waterproof protective housing for printer module 6b during a cleaning process.

According to FIG. 4, frame 4 of protective hood 2 forms a precisely fitting enclosure or receptacle 4' for attachment plate 13b so that frame 4 can be placed in a positive-fit manner along a plate edge 15 of attachment plate 13b in a sealing manner. Frame 4 then forms a positive-fit receptacle 4' for attachment plate 13b.

Provided on frame 4 are attachment elements 16, as shown in FIG. 4, by way of which protective hood 2 can be locked to attachment plate 13b. After a cleaning process has been carried out, protective hoods 2 can be easily removed from respective attachment plate 13a, 13b so that printer modules 6a, 6b can again be moved back into region A within printer rack 12.

FIG. 5 shows printer device 9 in an exemplary application on a flow-packaging machine 11 for printing onto a packaging film 17. Packaging film 17, which can be printed onto using printer device 9, is folded to a bag shape at a bag-forming station 18 for tubular enclosure of products P that are fed thereinto. A separating device for separating the respective bags is positioned in production direction R downstream of bag-forming station 18.

According to FIG. 5, printer modules 6a, 6b are each positioned in position B, i.e., moved out sideways from printer rack 12. Respective protective hoods 2 are mounted on attachment plates 13a, 13b. Two printer modules 6a, 6b are thus enclosed in a waterproof manner to prevent contact with a cleaning fluid during a cleaning process.

FIG. 6 shows a section of a deep-drawing packaging machine 20 with a forming station 21 for producing cavities M, a sealing station 22 for closing cavities M with a top film 23, a transverse cutting station 24, and a longitudinal cutting station 25 for separating packages. A residual film grid winding station 26 is located at the exit of deep-drawing packaging machine 20. These stations are arranged in production direction R one behind the other in this order. Printer device 9 is intended for printing onto top film 23. Printer device 9 comprises a single printer module 6a, 6b which, as shown in FIG. 6, is positioned such that it is moved laterally out of printer rack 12, where a protective hood 2 is attached to an attachment plate 13 supporting printer module 6a, 6b to enclose printer module 6a, 6b in a waterproof manner.

FIG. 7 shows a tray sealing machine 30 with a printer device 9 for printing onto a top film which can be fed from a top film receiver 31 to printer device 9. Furthermore, tray sealing machine 30 comprises a sealing station 32 for sealing tray members provided therein with the top film that has been printed onto. According to FIG. 7, a protective hood 2 is attached to an attachment plate 13' on which a printer module 6a, 6b (not shown) is mounted for receiving printer module 6a, 6b in a manner sealed against the exterior. With protective hood 2 mounted, no cleaning fluids can reach printer module 6a, 6b during a cleaning process of tray sealing machine 30. After the cleaning process, protective hood 2 can be easily removed from attachment plate 13' and stored in a space-saving manner.

Protective hood 2 shown in the figures can be used universally on various printer devices as long as hood opening 3 formed thereon with an attachment plate 13, 13b supporting printer module 6a, 6b can be sealed in a waterproof manner. Protective hoods 2 according to the disclosure, together with existing attachment plates 13a, 13b on which printer modules 6a, 6b are mounted, then together form a reliable protective housing for respective printer modules 6a, 6b during a cleaning process.

What is claimed is:

1. A printer protection device for a printer module used at a packaging machine, which printer module can be controlled to produce a print image on labels or to produce a print image on a packaging film, wherein the printer protection device comprises a waterproof foldable protective hood with a hood opening that is configured to receive, in a sealing manner, an attachment plate that supports the printer module.

2. The printer protection device according to claim 1, wherein the protective hood comprises a frame that defines the hood opening and is configured as a skirting for the attachment plate.

3. The printer protection device according to claim 2, wherein the frame is produced from PVC.

4. The printer protection device according to claim 2, wherein the frame comprises at least one sealing element that is attachable in a sealing manner to a circumference of the attachment plate.

5. The printer protection device according to claim 1, wherein the printer protection device comprises the attachment plate supporting the printer module, and wherein the protective hood is detachably attachable to the attachment plate.

6. The printer protection device according to claim 1, wherein the protective hood is lockable to the attachment plate.

7. The printer protection device according to claim 1, wherein the protective hood is made from PVC canvas or from polyester fabric.

8. The printer protection device according to claim 7, wherein the PVC canvas comprises PVC-coated polyester fabric.

9. The printer protection device according to claim 1, wherein the protective hood has welded seams.

10. The printer protection device according to claim 1, wherein the protective hood comprises a cuboid-shaped hood.

11. A printer device comprising a printer rack and a printer module mounted thereon to be movable with respect to the printer rack, wherein the printer module is movable together with an attachment plate supporting the printer module from a region located inside the printer rack to a position located outside the printer rack in which the printer protection device according to claim 1 is attachable to the attachment plate.

12. A packaging machine configured as a deep-drawing packaging machine, a tray sealing machine, or a flow-packaging machine, comprising the printer device according to claim 11.

13. A printer device comprising a printer rack, parallel guides associated with the printer rack, multiple attachment plates that are movable along the parallel guides, and multiple printer modules that are each supported by a respective one of the attachment plates, wherein each of the printer modules is movable, together with the respective attachment plate, from a region located inside the printer rack to a position located outside the printer rack in which the printer protection device according to claim 1 is attachable to the respective attachment plate.

14. A method for configuring a packaging machine for a cleaning process, the method comprising:
placing a waterproof foldable protective hood in a sealing manner, by way of a hood opening formed thereon, onto a plate edge of an attachment plate used to support a printer module, which plate edge is formed to correspond to the hood opening.

15. The method according to claim 14, wherein placing the protective hood onto the plate edge of the attachment plate comprises moving the attachment plate together with the printer module mounted thereon to a position located outside of a printing region.
